(19) United States
(12) Patent Application Publication
(10) Pub. No.: US 2023/0394284 A1
(43) Pub. Date: Dec. 7, 2023

(54) METHOD AND SYSTEM FOR PREDICTING TRAJECTORIES FOR MANEUVER PLANNING BASED ON A NEURAL NETWORK

(71) Applicant: Continental Automotive Technologies GmbH, Hannover (DE)

(72) Inventors: Stefan Zwicklbauer, Pocking (DE); Muhammad Ali Chattha, Kaiserslautern (DE); Sheraz Ahmed, Kaiserslautern (DE); Ludger van Elst, Kaiserslautern (DE)

(73) Assignee: Continental Automotive Technologies GmbH, Hannover (DE)

(21) Appl. No.: 18/249,214

(22) PCT Filed: Oct. 12, 2021
(86) PCT No.: PCT/EP2021/078162

§ 371 Date: Apr. 14, 2023

(30) Foreign Application Priority Data
Oct. 14, 2020 (EP) 20201677.0

(51) Int. Cl. G06N 3/0455; G06N 3/08

(52) U.S. Cl. CPC G06N 3/0455; G06N 3/08; B60W 60/001

(57) ABSTRACT

A computer-implemented method for predicting trajectories is disclosed based on a main neural network by fusing data-driven and knowledge-driven features. The method includes: receiving first input information as time-dependent numerical information; receiving second input information, as rule- or knowledge-based information including one or more trajectory prediction information; processing second input information by using an auto-encoder configured to encode the second input information by extracting features from the second input information, thereby obtaining encoded second input information; providing the encoded second input information to a fusion network, the fusion network providing transformed information obtained by transforming encoded second input information according to properties of the main neural network; providing the first input information and the transformed information to the main neural network, the main neural network fusing the first input information and the transformed information in order to provide trajectory predictions based thereon; and outputting the trajectory prediction.

### CROSS-REFERENCE TO RELATED APPLICATIONS

The present application is a National Stage Application under 35 U.S.C. § 371 of International Patent Application No. PCT/EP2021/078162 filed on Oct. 12, 2021, and claims priority from European Patent Application No. 20201677.0 filed on Oct. 14, 2020, in the European Patent Office, the disclosures of which are herein incorporated by reference in their entireties.

### TECHNICAL FIELD

The present invention relates generally to the field of neural networks, specifically deep neural networks. More specifically, the invention relates to a method and a system for predicting trajectories based on first input information, e.g., time-dependent sensor information, and second input information which are rule- or knowledge-based information (e.g., set of rules, knowledge graphs etc.).

### BACKGROUND

Trajectory prediction plays an important role as well for Advanced Driver Assistance Systems as for Systems for Automated Driving (ADAS and AD systems). Trajectory prediction is essential for planning a maneuver for an ego vehicle in a situation with further traffic participants. Deep neural networks have proven useful for trajectory prediction.

Shun Feng Su and Sou-Horng Li show in “Neural Network Based Fusion of Global and Local Information in Predicting Time Series”, IEEE International Conference on Systems, Man and Cybernetics. 2003 vol. 5, 5 Oct. 2003, pages 4445-4450—XP010668646, ISBN 978-0-7803-7952-7, that neural networks can be employed as global prediction schemes and a Fourier Gray Model (FGM) is employed as a local prediction scheme. The FGM result may be included as another input to the neural network. The weight for the FGM result may be adopted to match the importance of the local prediction with respect to the original input for the neural network.

Deep Learning Research has shown that neural networks, specifically deep neural networks, require a significant number of training samples to be trained in order to achieve acceptable prediction results. Thus, in industrial applications, training data is a valuable asset and often not available to that extent that is needed to obtain promising results.

As a starting point for finding better prediction methods serves the conclusion that predictors need to be developed in a way to work with fewer training examples or allow to incorporate predictions that have already been made by another predictor (e.g., an expert system predictor). Predicting trajectories is a prominent example of predicting time series data.

Neural networks require a numerical representation of data. However, other knowledge representations do exist (e.g., rule-based systems, knowledge-graphs, etc.) that allow to predict situations or values based on symbolic data representation. Current neural-network forecasting approaches often lack possibilities to incorporate knowledge-driven or rule-base predictors.

Several considerations regarding an optimization of trajectory planning are presented:
1. Neural networks require a numerical representation of data. For traditional trajectory prediction approaches, this is normally image and/or trajectory (e.g., functions or pure numbers) data. However, other knowledge representations do exist (e.g., rule-based systems, knowledge-graphs) that allow to predict situations or values based on symbolic data representation. Current neural-network (trajectory) prediction approaches often lack possibilities or are not flexible enough to incorporate knowledge-driven (e.g., rule-base) predictors.
2. Deep Learning Research has shown that (deep) neural networks require a significant number of training samples to achieve state-of-the-art results. For trajectory prediction training data is available in the meantime, however, not enough for very specific scenarios. But very specific and seldom traffic scenarios need to be solved appropriately to avoid accidents or dangerous scenes. As a result, predictors need to be developed in a way to work with fewer training examples or allow to incorporate predictions that have already been made by another predictor (e.g., motion model). Unfortunately, this research directions have been neglected and, thus, many state-of-the-art forecasting systems still cannot be used for all industrial applications.
3. Many trajectory prediction systems consider various information sources (e.g., visual data, trajectory data etc.). Also, works often incorporate multiple prediction systems or other expert systems (e.g., knowledge graphs with traffic rules) into their architecture. Since the output of expert/trajectory prediction systems differs from system to system, we need to adapt the main trajectory predictor network according to the other networks. Current neural network-based approaches are typically not agnostic to the available expert/trajectory systems. Thus, the main predictor needs to be aligned with the incorporated systems and its architecture needs to be evaluated and eventually re-designed.
4. Incorporating multiple trajectory prediction models at forecasting level by using ensemble methods like bagging or boosting is well-known but does not allow the main trajectory predictor network to leverage strengths of other models directly. Instead, the predictions are calculated separately for each model and combined/integrated afterwards. As each of the models in the ensemble are working in isolation, they do not contribute in parametric optimization of other networks and as a result, networks in the ensemble cannot benefit from strengths or information contained in other networks.

An aspect of the present disclosure concerns a computer implemented method for trajectory prediction for maneuver planning that uses knowledge sharing. Past temporal values of the desired variable are used and combined with additional information extracted from predictions made by other trajectory prediction systems to come up with predictions of future values of the target variable. The present disclosure allows to combine multiple trajectory prediction systems or knowledge and data-driven techniques. Hereby, it may significantly improve accuracy and makes the underlying neural net(s) less dependent on data.

Generally, Neural Networks learn features from the data that are helpful in coming up with predictions for the task they are being trained to solve.

According to an aspect of the present disclosure, a trajectory prediction system based on neural networks is enabled to use knowledge from other modalities apart from the data, by fusing information to latent space(s) of the main underlying neural network. This enables the trajectory prediction system to learn a transfer function based on information contained in expert and data domain. In the following, we refer as an example to the expert system(s) as additional (knowledge-based) sources for trajectory prediction.

It is an objective of the embodiments of the present disclosure to provide a method for prediction trajectories based on a neural network which uses data-driven and rule- or knowledge-driven information as inputs and provides predictions of trajectory information by using both, data-driven and knowledge-driven information in order to lower training data requirements and/or to provide improved predictions in cases where ample data is available, as it combines information from both knowledge and data domains. The objective is addressed by the features of the independent claims. Example embodiments are given in the dependent claims. If not explicitly indicated otherwise, embodiments of the present disclosure can be freely combined with each other.

According to an aspect, the present disclosure refers to a method for predicting trajectories based on a main neural network. The method includes the following steps:

At first, first input information is received. The first input information is time-dependent numerical information, for example output information of a sensor. More specifically, first input information may be provided by a sensor of an advanced driver assistance system or a perception system for automated driving, e.g., a radar, lidar, ultrasonic sensor, an image sensor or a camera. The first input information may include information regarding the environment in the surrounding of the vehicle in which the sensor is included. The sensor data may include information on positions and motion of the own vehicle and further traffic participants. Trajectories may be extractable over time from the sensor data.

Furthermore, second input information is received, the second input information being rule- or knowledge-based information. The second input information may be, for example, trajectory predictions made by an expert system. The second input information is associated with first input information. For example, second input information may provide rules or additional knowledge which relates to the context of first input information but are provided by another information source (e.g., database, knowledge graph, another neural network etc.).

The second input information is processed by using an auto-encoder or based on an auto-encoder. The auto-encoder is configured to encode second input information by extracting features from the second input information, thereby obtaining encoded second input information. The encoded second input information may be condensed information of second input information, i.e. still includes relevant information but redundant information has been removed.

The second input information can be represented numerically or non-numerically. As an example for non-numerical information, a knowledge graph is considered. The graphically coded information contained in a knowledge graph can be translated by Graph Neural Networks into numerical information. As an example, a graph can be represented with the help of an adjacency matrix.

Another possibility consists in translating the graph-based information into vectors (cf. the research field: knowledge representation learning). This could be done by a first layer of the auto-encoder. Hence a numerical input for the following layer(s) of the auto-encoder is available.

The encoded second input information is provided to a fusion network. The fusion network provides transformed information which is obtained by transforming encoded second input information according to properties of the main neural network. By using auto-encoder and fusion network, second input information may be transformed such that the output of fusion network, i.e. transformed information lies in the same vector space as features included in a hidden space of main neural network. Thereby fusion of rule- or knowledge-based information with time-resolved trajectory data is possible.

Finally, first input information and transformed information are provided to the main neural network, the main neural network fusing first input information and transformed information in order to provide trajectory predictions based on first input information and transformed information.

The obtained trajectory predictions may be output to an ADAS or AD system which can perform maneuver planning for the own vehicle by taking into account the predicted trajectories.

The method is advantageous because combination of different information from different information sources is possible thereby reducing the effort for providing sufficient training data. In addition, using the auto-encoder and the fusion network, projection of second input information, specifically expert predictions, into the domain of main neural network is possible without restrictions on the model architecture of the information source providing second input information.

According to an embodiment, the auto-encoder includes an encoder portion which maps second input information to a latent feature space comprising lower dimensionality than second input information. Thereby, the auto-encoder provides a condensed version of second input information which may be represented by a lower number of bits. However, the auto-encoder is trained such that relevant information is still included in encoded second input information, but redundant information is removed.

According to an embodiment, the fusion network adapts the dimensionality of feature vector provided by the auto-encoder to the dimensionality of a certain hidden layer of main neural network. In other words, encoded second input information is tailored by fusion network such that transformed information obtained by the tailoring or transformation step can be directly included in a hidden layer of main neural network, i.e., matches to the vector space of a certain hidden layer. Thereby, it is possible to train the weighting factors of main neural network based on both information, first input information being time-dependent numerical information and rule- or knowledge-based expert information/expert predictions.

According to an embodiment, the step of adapting dimensionality includes transforming at least one dimension of feature vectors provided by the auto-encoder to at least one dimension of the vector space of the certain hidden layer such that at least one dimension of transformed information is equal to at least one dimension of vector space of the certain hidden layer. Thereby it is possible to add transformed information, for example as a further row or column to the hidden layer of the neural network.

According to an embodiment, the fusion network projects encoded second input information provided by auto-encoder into latent subspace, specifically, vector space of a certain hidden layer of main neural network. Thereby encoded second input information is transformed according to the architecture of the main neural network which may be predetermined by the nature of first input information to be processed by the main neural network.

According to an embodiment, transformed information is concatenated with the features included in a certain hidden layer of the main neural network. The features already included in a certain hidden layer are influenced solely by first input information. In contrary thereto, transformed information is influenced by second input information. After the concatenation, a set of features is provided to the next hidden layer which is influenced by both, first and second input information and the main neural network can be trained based on both information.

According to an embodiment, the step of concatenating transformed information with features of a certain hidden layer includes increasing the dimensionality of vector space of a hidden layer. For example, the concatenating step may include adding one or more rows or columns to the vector space of hidden layer. Thereby a fusion of data-based and rule- or knowledge-based information in a single neural network can be obtained.

According to an embodiment, the dimensionality is increased such that the vector space of the hidden layer in which transformed information are projected is the sum of dimensionality of features resulting from first input information and resulting from transformed information.

According to a further aspect, the present disclosure relates to a system for predicting trajectories, the system comprising an auto-encoder, a fusion network and a main neural network. The system is configured to perform the steps of:
Receiving first input information, the first input information being time-dependent numerical information;
Receiving second input information, the second input information being rule- or knowledge-based information including one or more trajectory prediction information;
Processing the second input information based on the auto-encoder, the auto-encoder being configured to encode second input information by extracting features from the second input information, thereby obtaining encoded second input information;
Providing the encoded second input information to the fusion network, the fusion network providing transformed information which is obtained by transforming encoded second input information according to properties of the main neural network; and
Providing the first input information and the transformed information to the main neural network, the main neural network being configured to fuse the first input information and the transformed information in order to provide trajectory predictions based on the first input information and the transformed information.

The system is advantageous because a combination of different information from different information sources is possible thereby reducing the effort for providing sufficient training data. In addition, using the auto-encoder and the fusion network, projection of second input information into the domain of the main neural network is possible without restrictions on the model architecture of the information source providing second input information.

According to an embodiment of the system, the fusion network is configured to adapt the dimensionality of feature vector provided by the auto-encoder to the dimensionality of a certain hidden layer of the main neural network. In other words, encoded second input information is tailored by fusion network such that transformed information obtained by the tailoring or transformation step can be directly included in a hidden layer of the main neural network, i.e., matches to the vector space of a certain hidden layer. Thereby, it is possible to train the weighting factors of the main neural network based on both information, namely first input information being time-dependent numerical information and rule- or knowledge-based expert information.

According to an embodiment of the system, the fusion network is configured to adapt the dimensionality of feature vector such that at least one dimension of feature vector provided by the auto-encoder is transformed to at least one dimension of the vector space of the certain hidden layer such that at least one dimension of transformed information is equal to at least one dimension of vector space of the certain hidden layer. Thereby it is possible to add transformed information, for example as a further row or column to the hidden layer of the neural network.

According to an embodiment of the system, the fusion network is configured to project encoded second input information provided by the auto-encoder into latent subspace, specifically, vector space of a certain hidden layer of the main neural network. Thereby encoded second input information is transformed according to the architecture of the main neural network which may be predetermined by the nature of first input information to be processed by the main neural network.

According to an embodiment of the system, transformed information is concatenated with the features of a certain hidden layer of the main neural network. The features already included in a certain hidden layer are influenced solely by first input information. In contrary thereto, transformed information is influenced by second input information. After the concatenation, a set of features is provided to the next hidden layer which is influenced by both, first and second input information and the main neural network can be trained based on both information.

According to an embodiment of the system, the step of concatenating transformed information with features of a certain hidden layer includes increasing the dimensionality of vector space of a hidden layer. For example, the concatenating step may include adding one or more rows or columns to the vector space of hidden layer. Thereby a fusion of data-based and rule- or knowledge-based information in a single neural network can be obtained.

According to an embodiment of the system, the dimensionality is increased such that the vector space of the hidden layer in which transformed information are projected is the sum of the dimensionality of features resulting from first input information and resulting from transformed information.

Examples for knowledge systems can be extracted from the following trajectory prediction methods:

EP 3798912 A1 describes a training method for a convolutional neural network for predicting a driving maneuver of at least one traffic participant in a traffic scenario of an ego-vehicle.

Nachiket Deo et al. present in “Convolutional Social Pooling for Vehicle Trajectory Prediction” a prediction method which is trained by using publicly available NGSIM US-101 and 1-80 datasets comprising track histories.

Any upper-mentioned feature described as an embodiment of the method is also applicable as a system feature in the system according to the present disclosure.

The term “vehicle” as used in the present disclosure may refer to a car, truck, bus, train or any other crafts.

The term “time-dependent numerical information” may refer to any information which may be presented by numerical values, e.g., digital numbers, integers, floats, etc.

The term “knowledge-based information” may refer to any information provided by a knowledge-based system. The information may include facts or guidelines regarding a certain topic which can be used for providing predictions or may be predictions from a knowledge-based system. More specifically, knowledge-based information may be expert predictions, wherein an “expert” can be any other system based on logic rules, statistical rules, expert humans, etc.

The term “rule-based information” may refer to any information provided by a rule-based system which includes rules or principles regarding a certain topic based on which predictions can be made or may be rule-based predictions.

The term “hidden layer” may refer to an intermediate layer of a neural network which may be located between an input and an output of the neural network.

The term “essentially” or “approximately” as used in the present disclosure means deviations from the exact value by +/−10%, preferably by +/−5% and/or deviations in the form of changes that are insignificant for the function and/or for the traffic laws.

### BRIEF DESCRIPTION OF THE DRAWINGS

Various aspects of the invention, including its particular features and advantages, will be readily understood from the following detailed description and the accompanying drawings, in which:

FIG. 1A shows a first embodiment of a system for predicting trajectories based on first and second input information;

FIG. 1B shows a second embodiment comprising a variant of the system for predicting trajectories based on first and second input information;

FIG. 2 shows a third embodiment of a system for predicting trajectories based on first, second and third input information; and

FIG. 3 shows a flowchart illustrating the method steps for predicting trajectories based on first and second input information.

### DETAILED DESCRIPTION

The present disclosure will now be described more fully with reference to the accompanying drawings, in which example embodiments are shown. The embodiments in the figures may relate to preferred embodiments, while all elements and features described in connection with embodiments may be used, as far as appropriate, in combination with any other embodiment and feature as discussed herein, in particular related to any other embodiment discussed further above. However, this present disclosure should not be construed as limited to the embodiments set forth herein. Throughout the following description similar reference numerals have been used to denote similar elements, parts, items or features, when applicable.

The features of the present disclosure disclosed in the specification, the claims, examples and/or the figures may both separately and in any combination thereof be material for realizing the present disclosure in various forms thereof.

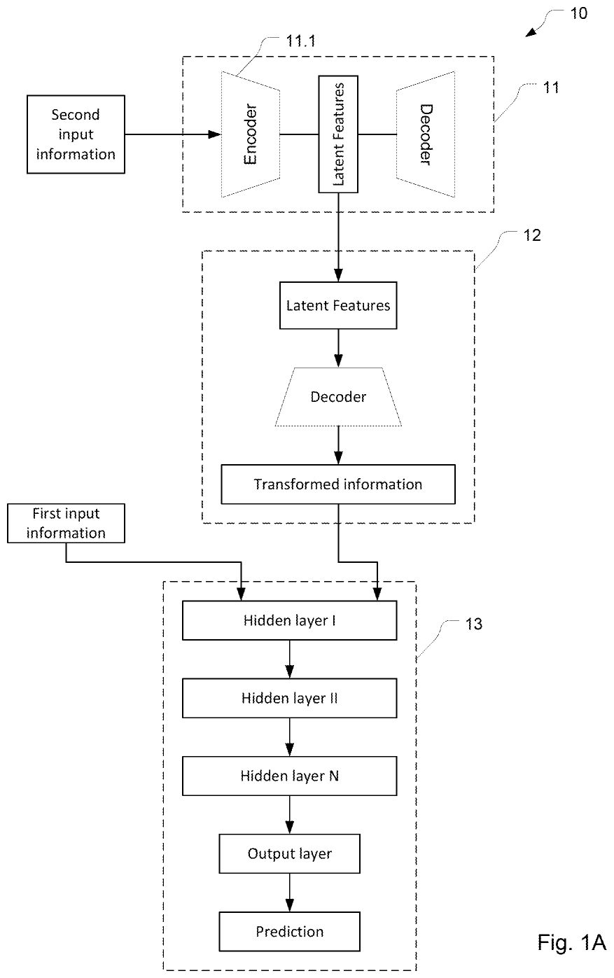

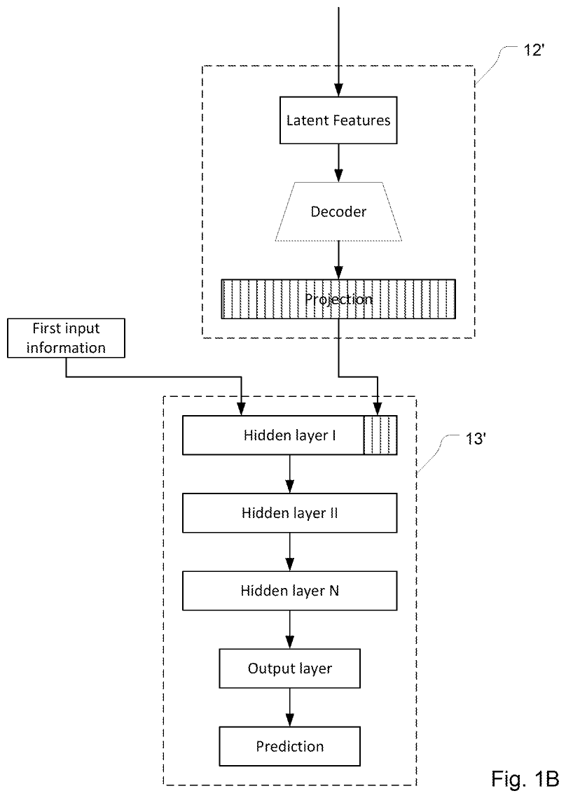

FIG. 1A illustrates an example system 10 for providing predictions based on first input information which are trajectory-related time series information and second input information which may be, for example, expert predictions from a data-driven information source.

As described further below, first input information may be time-dependent information which may be provided by a sensor included in a vehicle in order to provided autonomous driving capabilities based on the sensor information. In the present disclosure, such time-dependent information is also referred to as data-driven information.

Second input information may be information of a different information source. In contrary to first input information, the second input information are knowledge-based information.

The system 10 is configured to combine information of different information type, namely data-driven information and knowledge-based information and provide information based on both information types. More in detail, the information of different information types are merged in a single neural network, specifically a single deep neural network such that the values of a feature vector of a certain hidden layer are chosen based on first and second input information.

The system 10 includes an auto-encoder 11, a fusion network 12 and a main neural network 13 for providing predictions based on first and second input information. In other words, the system 10 includes the following three constituent networks: an auto-encoder based feature extractor 11, a fusion network 12 which takes latent information learned from the auto-encoder as an input to its decoder which generates transformed information, and the main neural network 13, i.e., the “Trajectory Predictor Network.”

The auto-encoder 11 receives second input information which may be predictions from an expert system. The auto-encoder 11 may be an artificial neural network which is configured to learn efficient data codings of second input information in an unsupervised manner.

The auto-encoder 11 includes an encoder portion 11.1 which receives the second input information and provides encoded second input information. The auto-encoder 11 is configured to learn efficient encodings of the data. More specifically, the auto-encoder 11 may reduce dimensionality of information by learning to ignore redundant information in the data, i.e., auto-encoder 11 is configured to provide encoded second input information which are still representative of second input information. In FIG. 1A, encoded second input information are identified as latent features. In the following, the wording is used synonymously. So, in other words, latent features are an efficient encoding of second input information. Encoded second input information may be a vector including a certain number of digital bits.

An auto-encoder based feature extractor which extracts useful features from trajectory predictions made by expert networks (e.g., visual trajectory prediction system). Since the trajectory prediction system only requires predictions made by the expert system, it is fully agnostic to the expert model's used architecture. The auto-encoder is first trained on trajectory predictions made by the expert system to learn compressed feature representations (latent information; encoded second input information). This representation encodes salient information contained in the knowledge driven method.

The encoded second input information (i.e., the latent features) which is the output of the auto-encoder 11 is provided to the fusion network 12 as an input. The fusion network 12 is configured to project encoded second input information into latent sub-space of the main neural network 13. In other words, the fusion network transforms encoded second input information such that the size and/or structure of transformed information provided as an output of fusion network 12 fits to the sub-space of the hidden layer of main neural network 13.

For performing the transformation process, the fusion network 12 includes at least one decoder 12.1. The decoder 12.1 of the fusion network 12 is configured to receive encoded second input information and to transform the encoded second input information into transformed information. The transformed information may have the same dimension or at least one common dimension as the vector space of the hidden layer of the main neural network 13 to which the transformed information is added. The decoder 12.1 of the fusion network 12 may be trained along with the main neural network 13.

It is worth mentioning that adding information of a knowledge-driven information source to a certain hidden layer is not limited to one hidden layer but the information fusion can also be performed in multiple layers.

FIG. 1B illustrates details of a variant of the system illustrated in FIG. 1A. A variant of the first fusion network 12′ includes a decoder which generates a projection of the latent features (compressed feature representation) which were generated by the auto-encoder 11 from the second input information. The projection is fed into the Hidden Layer I of a variant of the main neural network 13′.

The fusion network 12′ takes the compressed trajectory feature vectors learned from the auto-encoder 11 as an input to a decoder. This decoder of the fusion network 12′ connects the compressed feature vectors to an intermediary layer of the main neural network 13′. The decoder of the fusion network 12′ serves two purposes,
(i) it matches the dimensionality of the compressed feature vectors with that of the hidden layer of the main neural network 13′, and
(ii), it projects the compressed feature vectors learned from the expert network into a latent sub-space of the main neural network 13′.

For example, a certain hidden layer of main neural network 13′ may have the vector space of 8×16. In order to be able to add encoded second input information provided by the auto-encoder 11 to the main neural network 13′, the fusion network 12′ has to adopt the size of encoded second input information to the dimension of the vector space, for example to 1×16 size. So, if encoded second input information has the dimension 1×12, the vector size of encoded second input information has to be increased to 1×16 in order to be able to add information included in encoded second input information as transformed information into latent space of the hidden layer. In the present embodiment, the final size of the hidden layer may be 9×16 which may be the input of the next hidden layer. In general, adding transformed information to the vector space of hidden layer is performed by concatenation, i.e., the vector space is increased by one or more rows or columns.

After concatenating, the further hidden layers are receiving information derived from first and second input information, i.e., from data-driven and knowledge-driven information. As such, the main neural network 13′ provides predictions based on both, data-driven and knowledge-driven information.

The decoder of the fusion network 12′ is trained along with the main neural network 13′ of this embodiment which is the “Trajectory Predictor Network.” This network is also agnostic to any architecture since the fusion network 12′ is generic and can be used with different neural network architectures. This step is represented at the bottom of FIG. 1B by the main neural network block 13′.

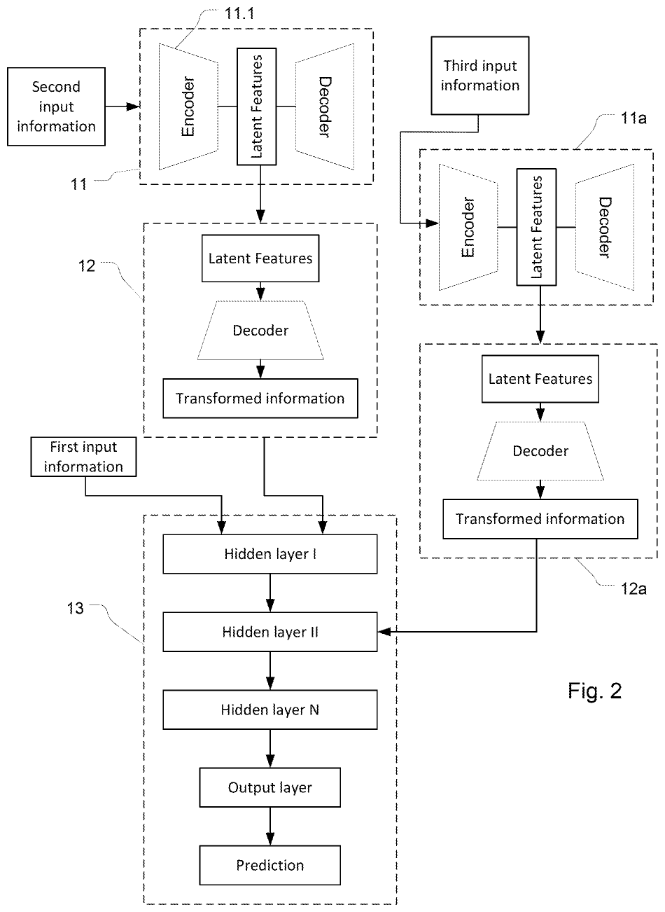

For example, as shown in FIG. 2, a first hidden layer may receive transformed information of a first fusion network 12 and a second hidden layer of the same main neural network 13 may receive transformed information of a second fusion network 12a. The second fusion network 12a is coupled with a second auto-encoder 11a. The second auto-encoder 11 receives third input information which may be also knowledge-based information provided by an expert data source. The third input information can be information identical to the second input information or can be different from the second input information. The third input information may be encoded by second auto-encoder 11a and transformed into transformed information by second fusion network 12a in order to be added to a further hidden layer of main neural network 13. Thereby, more than two different information can be fused in order to provide predictions.

The training of the system 10 is performed in multiple training steps.

In a first training step, the auto-encoder 11 is trained on second input information in order to learn compressed feature representations.

After training of auto-encoder 11, fusion network 12, specifically decoder 12.1 is trained together with main neural network 13.

The present disclosure can be used, for example, in the following use cases.

A possible application area of the disclosed method and system is autonomous driving applications with the goal of developing an at least partially self-driving car. With a huge number of individual situations to master in the road traffic, driver assistance systems and autonomous driving include neural networks which are configured to assess certain driving situations and provide future predictions of the driving situation. A possible use case may be maneuver planning with the goal to predict complex traffic situations over a significant time horizon. For instance, changing the lane entails specific maneuvers of all other traffic participants close by. As a result, lane changing demands a cooperative behavior of all traffics participants, with humans being easily able to perform these maneuvers due to their long driving experiences and their ability to predict traffic situations.

In the area of autonomous driving, it is advantageous to support and enhance the driving system with specific rules, world and/or expert knowledge and physical knowledge, which is typically stored in separate knowledge bases. Leveraging this knowledge to make separate knowledge-based predictions, the present disclosure can be used to incorporate knowledge-based predictions into a more sophisticated predictor for complex traffic situations.

Another, but related use case is the handling of pedestrians. Given a specific situation with a pedestrian walking along the road, expert knowledge in form of previously occurring situations or general world knowledge can be leveraged and integrated into a larger predictor network.

An additional use case may be controlled rule violation. For instance, the lane is partially blocked by an obstacle and the midline prohibits an overtaken action. In this case, the car needs to violate the rule of crossing the midline. Again, the respective forecasting predicts the approaching traffic by leveraging expert knowledge in the form of rules, world knowledge and physical knowledge.

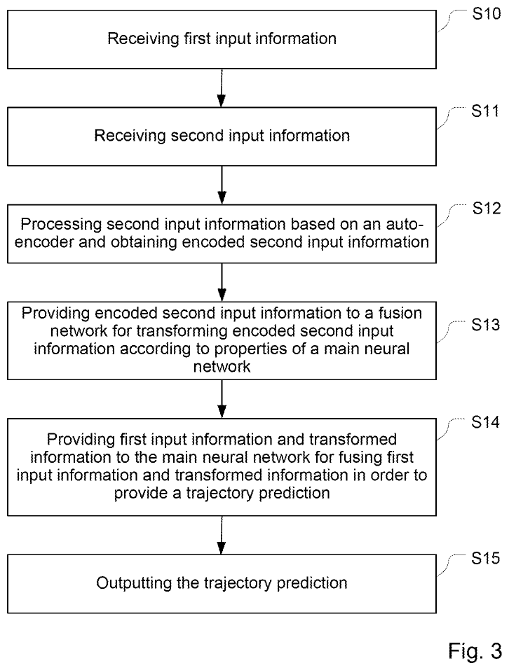

FIG. 3 shows a block diagram illustrating the method steps of a method for predicting trajectories based on a main neural network.

As a first step, first input information is received (S10). The first input information is time-dependent numerical information. The time-dependent numerical information may be provided by a sensor included or adapted to be included in a vehicle or may be provided by as an output of a computer system.

In addition, second input information is received (S11). The second input information is knowledge-based information including one or more prediction information. The prediction information is related to the first input information, so the second input information can be used for improving quality of predicted future trajectory values.

As a further step, second input information is processed based on an auto-encoder 11 (S12). The auto-encoder 11 is configured to encode the second input information by extracting features from the second input information, thereby obtaining encoded second input information.

The encoded second input information is provided to a fusion network 12. The fusion network 12 provides transformed information which are obtained by transforming the encoded second input information according to properties of the main neural network 13 (S13).

As a further step, the first input information and the transformed information are provided to the main neural network 13. The main neural network 13 fuses the first input information and the transformed information in order to provide a trajectory prediction based on the first input information and the transformed information (S14).

Finally, the provided trajectory prediction is output, e.g., to an ADAS or AD system for planning a maneuver by taking into account the trajectory prediction.

It should be noted that the description and drawings merely illustrate the principles of the proposed invention. Those skilled in the art will be able to implement various arrangements that, although not explicitly described or shown herein, embody the principles of the invention.

### LIST OF REFERENCE NUMERALS

10 system
11 auto-encoder
11a auto encoder
11.1 encoder portion
12 fusion network
12′ varied fusion network
12a fusion network
12.1 decoder
13 main neural network
13′ varied main neural network

1. Computer-implemented method for trajectory prediction based on a main neural network, the method comprising:
receiving first input information, the first input information being time-dependent numerical information;
receiving second input information, the second input information being rule- or knowledge-based information including one or more trajectory prediction information;
processing the second input information by using an auto-encoder, the auto-encoder being configured to encode the second input information by extracting features from the second input information, thereby obtaining encoded second input information;
providing the encoded second input information to a fusion network, the fusion network providing transformed information which is obtained by transforming encoded second input information according to properties of the main neural network.
providing the first input information and the transformed information to the main neural network, the main neural network fusing the first input information and the transformed information in order to provide a trajectory prediction based on the first input information and the transformed information; and
outputting the trajectory prediction.

2. Method according to claim 1, wherein the auto-encoder comprises an encoder portion which maps the second input information to a latent feature space comprising lower dimensionality than the second input information.

3. Method according to claim 1 or 2, wherein the fusion networker adapts a dimensionality of a feature vector provided by the auto-encoder to a dimensionality of a certain hidden layer of the main neural network.

4. Method according to claim 3, wherein the step adapting the dimensionality comprises transforming at least one dimension of feature vectors provided by the auto-encoder to at least one dimension of a vector space of the certain hidden layer such that at least one dimension of transformed information is equal to at least one dimension of the vector space of the certain hidden layer.

5. Method according to claim 1, wherein the fusion network projects the encoded second input information provided by the auto-encoder into a latent subspace of the main neural network.

6. Method according to claim 1, wherein the transformed information is concatenated with features of a certain hidden layer of main neural network.

7. Method according to claim 6, wherein concatenating the transformed information with the features of the certain hidden layer comprises increasing a dimensionality of vector space of a hidden layer.

8. Method according to claim 7, wherein the dimensionality is increased such that the vector space of the hidden layer in which the transformed information is projected is a sum of dimensionality of features resulting from the first input information and resulting from the transformed information.

9. System for predicting trajectories, the system comprising an auto-encoder, a fusion network and a main neural network, the system being configured to perform the steps of:
receiving first input information, the first input information being time-dependent numerical information;
receiving second input information, the second input information being rule- or knowledge-based information including one or more trajectory prediction information;
processing second input information by using the auto-encoder, the auto-encoder being configured to encode the second input information by extracting features from the second input information, thereby obtaining encoded second input information;
providing the encoded second input information to the fusion network, the fusion network providing transformed information which is obtained by transforming the encoded second input information according to properties of the main neural network;
providing the first input information and the transformed information to the main neural network, the main neural network being configured to fuse the first input information and the transformed information in order to provide a trajectory prediction based on the first input information and the transformed information; and
outputting the trajectory prediction.

10. System according to claim 9, wherein the fusion network is configured to adapt a dimensionality of feature vectors provided by the auto-encoder to a dimensionality of a certain hidden layer of the main neural network.

11. System according to claim 10, wherein the fusion networker is configured to adapt the dimensionality of the feature vectors such that at least one dimension of the feature vectors provided by the auto-encoder is transformed to at least one dimension of a vector space of the certain hidden layer such that at least one dimension of transformed information is equal to the at least one dimension of the vector space of the certain hidden layer.

12. System according to claim 9, wherein the fusion network is configured to project the encoded second input information provided by the auto-encoder into a latent subspace of the main neural network.

13. System according to claim 9, wherein the transformed information is concatenated with the features of a certain hidden layer of the main neural network.

14. System according to claim 13, wherein concatenating the transformed information with the features of the certain hidden layer comprises increasing a dimensionality of a vector space of a hidden layer.

15. System according to claim 14, wherein the dimensionality is increased such that the vector space of the hidden layer in which transformed information are projected is a sum of a dimensionality of features resulting from the first input information and resulting from the transformed information.
